(19) United States
(12) Patent Application Publication
(10) Pub. No.: US 2025/0245178 A1
(43) Pub. Date: Jul. 31, 2025

(54) LOW LATENCY COHERENT REMOTE MEMORY

(71) Applicant: Dell Products L.P., Round Rock, TX (US)

(72) Inventor: Adrian Michaud, Carlisle, MA (US)

(21) Appl. No.: 18/423,363

(22) Filed: Jan. 26, 2024

(51) Int. Cl. G06F 13/28

(52) U.S. Cl. CPC G06F 13/28; G06F 2213/28

(57) ABSTRACT

A system for managing shared remote memory includes a client device comprising a page fault handler and a virtual memory address space, a remote direct memory access (RDMA) network, and a remote memory server comprising a RDMA networking interface. The page fault handler is programmed to: obtain an application request associated with a virtual memory address of the virtual memory address space, decode the application request using the virtual memory address to identify a set of processor instructions in the application request, wherein each of the set of processor instructions invokes a page fault, generate, for each processor instruction, a RDMA request accessing a virtual memory region of the remote memory server, issue the RDMA request to the RDMA networking interface via the RDMA network, and adjust an instruction pointer of the processor instruction to service a second instruction pointer of the set of processor instructions.

### BACKGROUND

Computing devices may include any number of internal components such as processors, memory, and persistent storage. Applications executing on a computing device may utilize the computing resources of the computing device. Further, at least a portion of the computing resources, such as, for example, memory, utilized by the applications may be provided by external computing devices. The external computing resources may be operatively connected to the applications via a network.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments of the invention.

FIG. 1B shows a diagram of a remote memory server in accordance with one or more embodiments of the invention.

FIG. 2 shows a diagram of a relationship between a virtual memory address space of a client device and a virtual remote memory address space of a remote memory server in accordance with one or more embodiments of the invention.

FIG. 3A shows a first flowchart for a method for managing remote shared memory in accordance with one or more embodiments of the invention.

FIG. 3B shows a second flowchart for a method for managing remote shared memory in accordance with one or more embodiments of the invention.

FIG. 4 shows a flowchart for servicing RDMA requests in accordance with one or more embodiments of the invention.

FIGS. 5A-5B show an example in accordance with one or more embodiments of the invention.

FIG. 6 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N, A to P, A to M, or A to L. As used herein, the aforementioned labeling means that the element may include any number of items and does not require (unless stated otherwise) that the element include the same number of elements as any other item labeled as A to N, A to P, A to M, or A to L. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, operably connected, or operative connection, means that there exists between elements, components, and/or devices a direct or indirect connection that allows the elements to interact with one another in some way. For example, the phrase ‘operably connected’ may refer to any direct (e.g., wired directly between two devices or components) or indirect (e.g., wired and/or wireless connections between any number of devices or components connecting the operably connected devices) connection. Thus, any path through which information may travel may be considered an operable connection.

In general, embodiments of the invention may relate to a method and system for utilizing shared remote memory. Embodiments of the invention may include a client device utilizing a virtual memory address space for memory management. The virtual memory address space may not be mapped to any physical memory on the client device. Based on the lack of mapping, any application requests for storing data in virtual memory may invoke page faults. In conventional implementations, a page fault handler of the client device may manage the page faults of an application request by mapping the virtual memory addresses to physical memory, servicing the application request using the mapped physical memory, and indicating that the page faults are resolved.

In contrast to the aforementioned conventional implementations, embodiments disclosed herein modify the functionality of the page fault handlers to manage the page faults of an application request by virtualizing the processor instructions of the application requests. The virtualization may be performed by identifying the virtual memory regions (e.g., memory page offsets) of each processor instruction of an application request invoking page faults and generating, for each processor instruction, a remote direct memory access (RDMA) request to a remote memory server operatively connected to the client device via an RDMA-enabled network. The remote memory server may service the RDMA requests to access data (e.g., loading or storing) in its physical memory. By performing the virtualization of the processor instructions (which may include load or store instructions), the client device does not need to map the virtual memory address space of the client device to any physical memory. Further any page faults may be resolved without performing any mappings.

Various embodiments of the invention are described below.

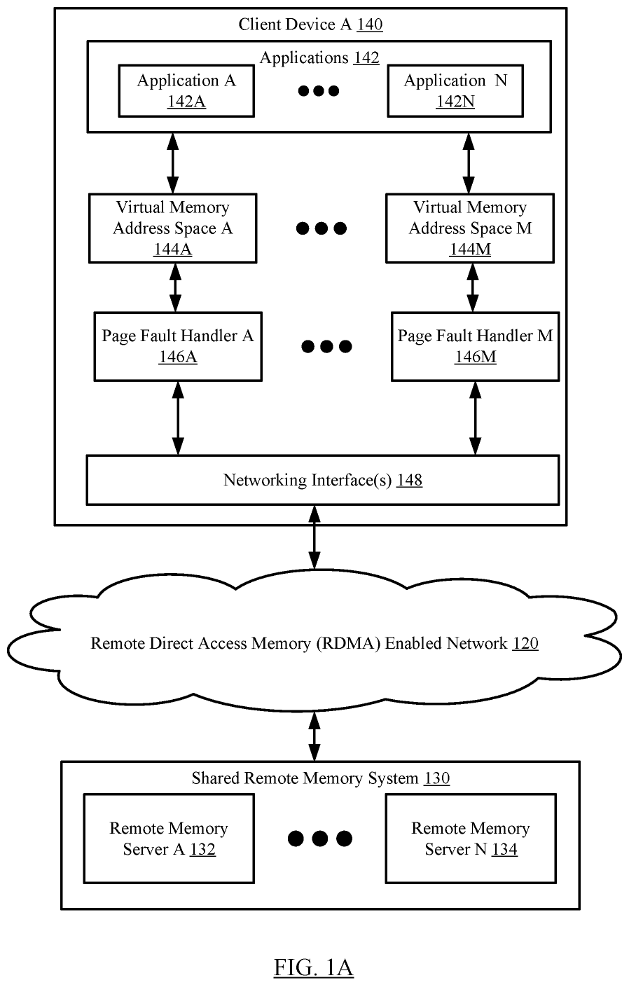

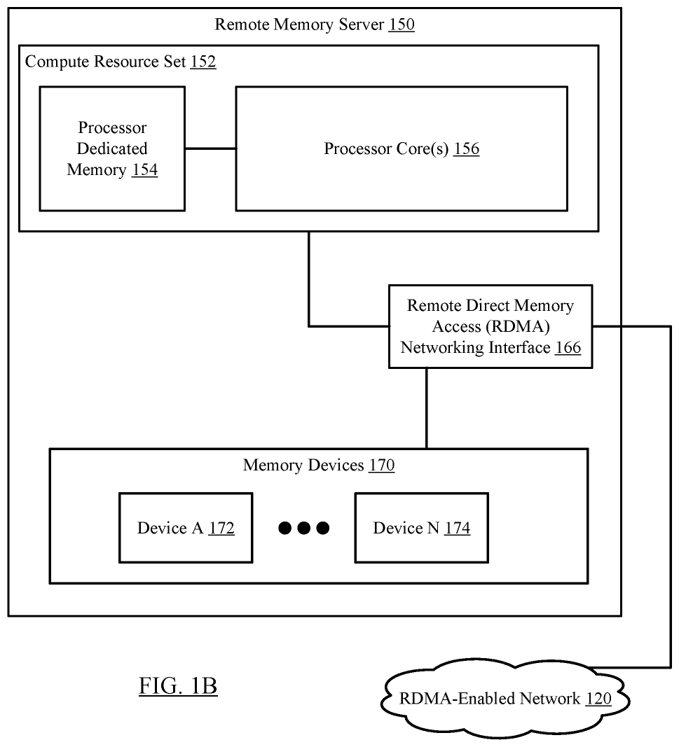

FIG. 1A shows an example system in accordance with one or more embodiments of the invention. The system includes a client device (140) and a shared remote memory system (130) operatively connected via a RDMA-enabled network (120). The components in the system may be operably connected via any combination of wired and/or wireless connections. The system may include additional, fewer, and/or different components without departing from the invention. Each component in the system is operably connected via any combination of wired and/or wireless connections.

In one or more embodiments of the invention, the client device (140) provide services to users. The services may be provided using applications (142A, 142N) executing on the client device (140). The applications (142A, 142N) may utilize data stored in memory. The applications may utilize data stored in persistent memory by the share remote memory system (130). The client devices (100) may access such data using a connection to the shared remote memory system (130) via the RDMA-enabled network (120).

In one or more embodiments, the applications (142) are logical entities executed using computing resources (not shown) of the client device (140). Each of the applications may be performing similar or different processes. In one or more embodiments of the invention, the applications (142A, 142N) provide services to users. For example, the applications (142) may host components. The components may be, for example, instances of databases, email servers, operating systems, and/or other components. The applications (142) may host other types of components without departing from the invention.

In one or more embodiments, the applications (142) store data in memory using virtual memory address spaces (144A, 144M). Each virtual memory address space (144A, 144M) is a logical partitioning of virtual memory to be provided to the applications (142). In one or more embodiments, the virtual memory address spaces (144A, 144M) are not mapped to any physical memory of the client device (140).

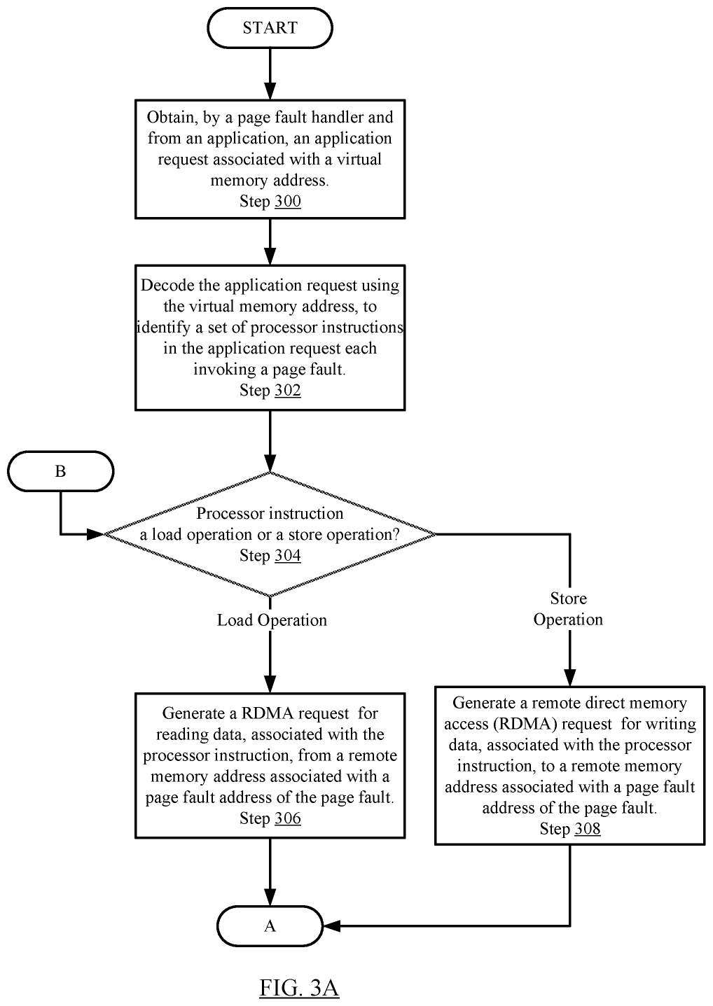

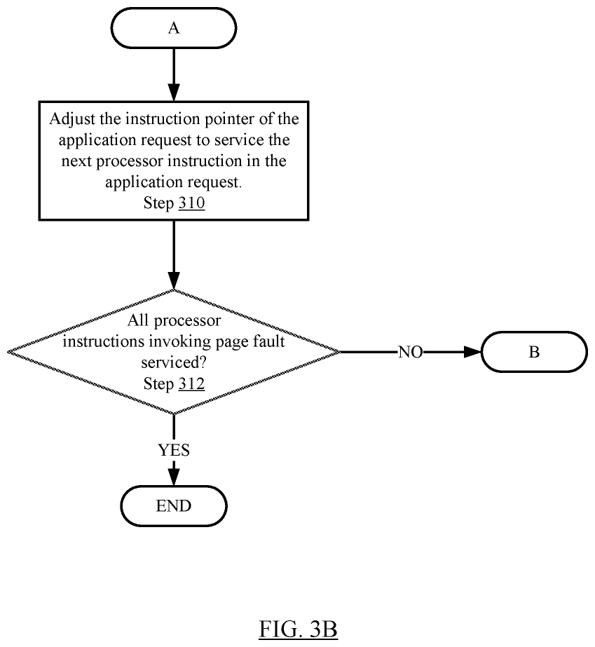

Because of the lack of mapping to physical memory, each request to store data using the virtual memory address spaces (144A, 144M) may invoke page faults. The page faults may be managed by the page fault handlers (146A, 146M) in accordance with, for example, FIGS. 3A-3B.

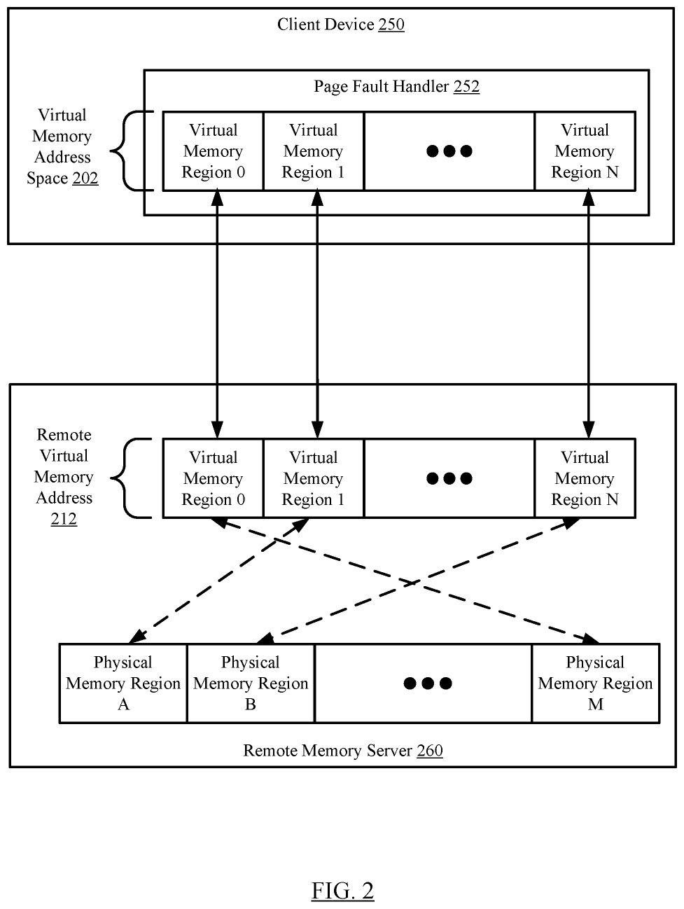

In one or more embodiments of the invention, each page fault handler (146A, 146M) includes functionality for managing the use of memory by the applications (142). The page fault handler (146A, 146M) manages the use of the memory by virtualizing the application requests for data by generating RDMA requests using the corresponding virtual memory regions (described in FIG. 2) of the requests and issuing the RDMA requests to the remote memory servers (132, 134) via the networking interfaces (148) and the RDMA-enabled network (120).

In one or more embodiments of the invention, each page fault handler (146A, 146M) is implemented as computer instructions, e.g., computer code, stored on a persistent storage (e.g., of the client device (140)) that when executed by a processor(s) of the client device (140) cause the client device (140) to provide the functionality of the page fault handler (146A, 146M) described throughout this application and/or all, or a portion thereof, of the methods described in FIGS. 3A-3B.

In one or more embodiments of the invention, the networking interfaces (148) include functionality for providing connection between the client device (140) and the shared remote memory system (130) via RDMA as discussed above. In one or more embodiments, the networking interfaces (148) include functionality for obtaining requests issued by the page fault handler (146A, 146M) and transmitting the requests to the networking interfaces of the remote memory servers (132, 134) via RDMA. The networking interfaces may be implemented, for example, as RDMA-enabled network interface controllers (RNICs). Each RNIC may manage communication between the client device (140) and one of the RDMA fabric devices in the RDMA fabric network.

In one or more embodiments, the networking interfaces (148) may be implemented using any suitable interconnection technology including, for example, system buses such as compute express links or other interconnection protocols. The networking interface (148) may support any input/output (IO) protocol, any memory protocol, any coherence interface, etc. The networking interface (148) may support processor to device connections, processor to memory connections, and/or other types of connections. The enhanced networking interface (148) may be implemented using one or more hardware devices including circuitry adapted to provide the functionality of the networking interface (148).

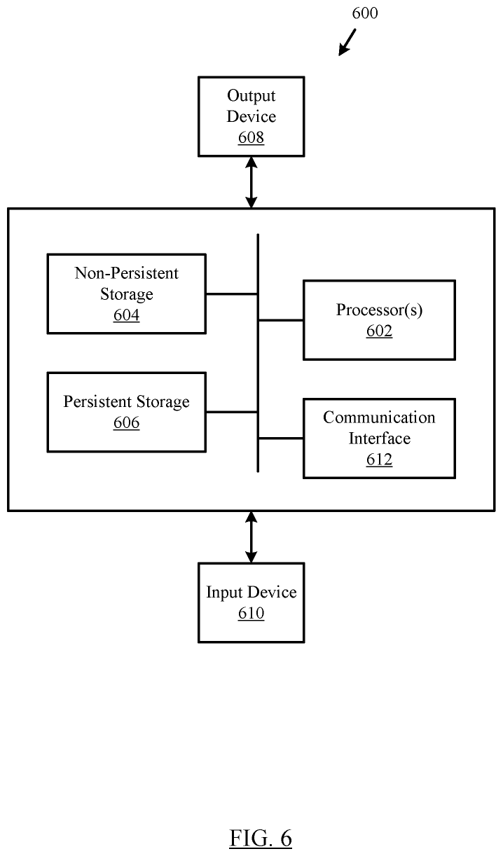

In one or more embodiments, the client device (140) is implemented as a computing device (see e.g., FIG. 6). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the client device (140) described throughout this application and/or all, or a portion thereof, of the methods described in FIGS. 3A-3B.

In one or more embodiments of the invention, the client device (140) is implemented as a logical device. The logical device may utilize the computing resources of any number of computing devices and thereby provide the functionality of the client device (140) described throughout this application and/or all, or a portion thereof, of the methods described in FIGS. 3A-3B.

In one or more embodiments of the invention, the RDMA-enabled network (120) includes one or more RDMA fabric devices (not shown) operatively connected to the client device (140) and one or more of the remote memory servers (132, 134) of the share remote memory system (130). In one or more embodiments, the RDMA-enabled network (120) includes functionality for accessing data in the share remote memory system (130) as requested by the page fault handlers (144A, 144M) of the client device (140). The RDMA fabric devices may access the data from the memory devices of the remote memory servers (132, 134). For example, the RDMA fabric devices may access the memory devices using RDMA. In one or more embodiments of the invention, RDMA is a mechanism for directly accessing memory stored in a remote location (e.g., in the share remote memory system (130)). RDMA fabric devices of the RDMA-enabled network (130) may access the remote memory servers (132, 134) without departing from the invention.

In one or more embodiments of the invention, the communication between the client device (140) and any of the remote memory servers (132, 134) produces negligible latency. In other words, one may estimate minimal latency between the client device (140) and a remote memory server (132, 134) communicating via the RDMA-enabled network (120).

In one or more embodiments of the invention, the share remote memory system (130) is a system of devices that used for storing memory to be used by the client devices (100). The share remote memory system (130) may include any number of remote memory servers (132, 134). Each remote memory server (132, 134) may store a portion of memory that is used by the applications (142) to perform the respective functionalities of the applications.

In one or more embodiments of the invention, each of the remote memory servers (132, 134) is implemented as a computing device (see e.g., FIG. 6). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the remote memory servers (132, 134) described throughout this application.

In one or more embodiments of the invention, one or more of the remote memory servers (132, 134) is implemented as a logical device. The logical device may utilize the computing resources of any number of computing devices and thereby provide the functionality of the remote memory servers (132, 134) described throughout this application. For additional details regarding a remote memory server (132, 134), see, e.g., FIG. 1B.

While the system of FIG. 1A has been illustrated and described as including a limited number of specific components, a system in accordance with embodiments of the invention may include additional, fewer, and/or different components without departing from the invention.

FIG. 1B shows a diagram of a remote memory server in accordance with one or more embodiments of the invention. The remote memory server (150) of FIG. 1B may be an embodiment of a remote memory server (132, 134, FIG. 1A) discussed above. The remote memory server (150) may include a compute resource set (152) that includes processor dedicated memory (154), one or more processor cores (156), one or more compute resources interfaces (162), a RDMA networking interface (166), and one or more memory devices (170). The remote memory server (150) may include additional, fewer, and/or different components without departing from the invention. Each of the components illustrated in FIG. 1B is discussed below.

In one or more embodiments, the compute resource set (152) may include one or more processor cores (156) operably connected to the processor dedicated memory (154) (e.g., cache). Consequently, the compute resource set (152) may host any number of executing processes thereby enabling any number and type of workloads to be performed. When performing the workloads, the compute resource set (152) may utilize computing resources provided by the hardware of the remote memory server (150).

The processor cores (156) of the compute resource set (152) may be operably connected to the memory devices (170). For example, the processor cores (156) may be connected to a compute resource interface (162), which is also connected to the memory devices (170).

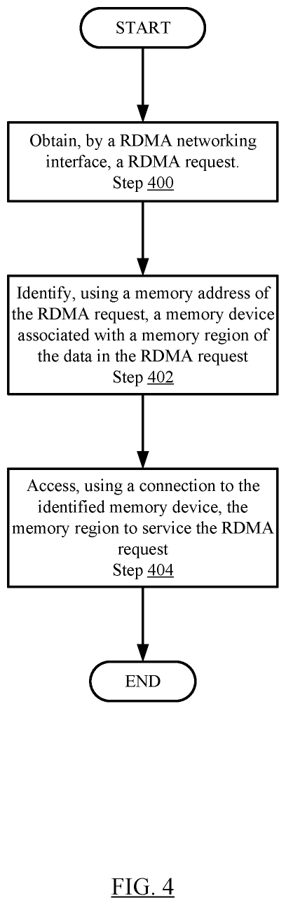

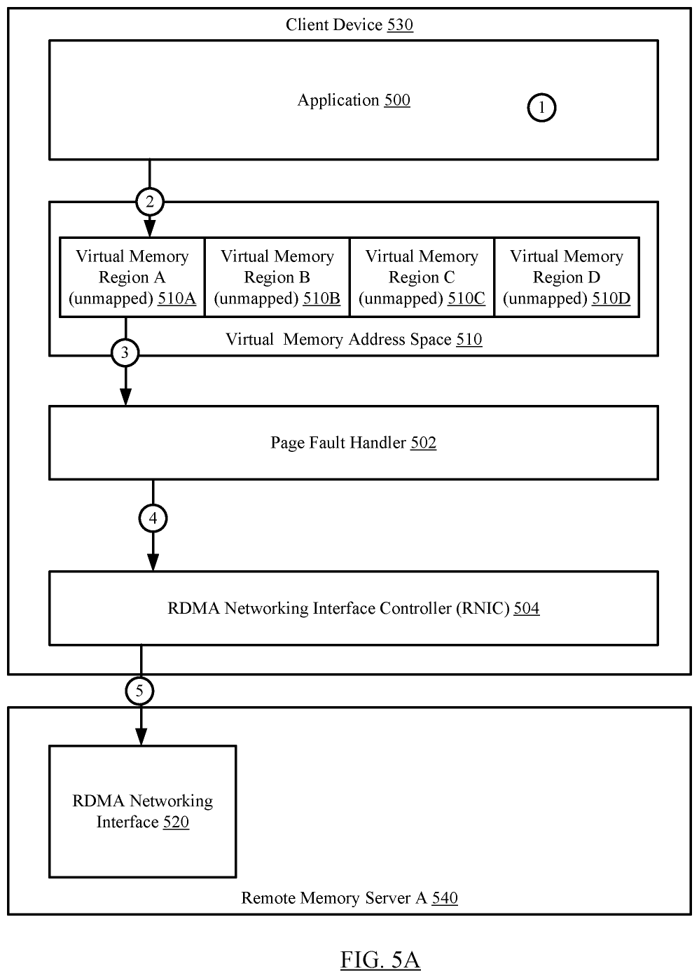

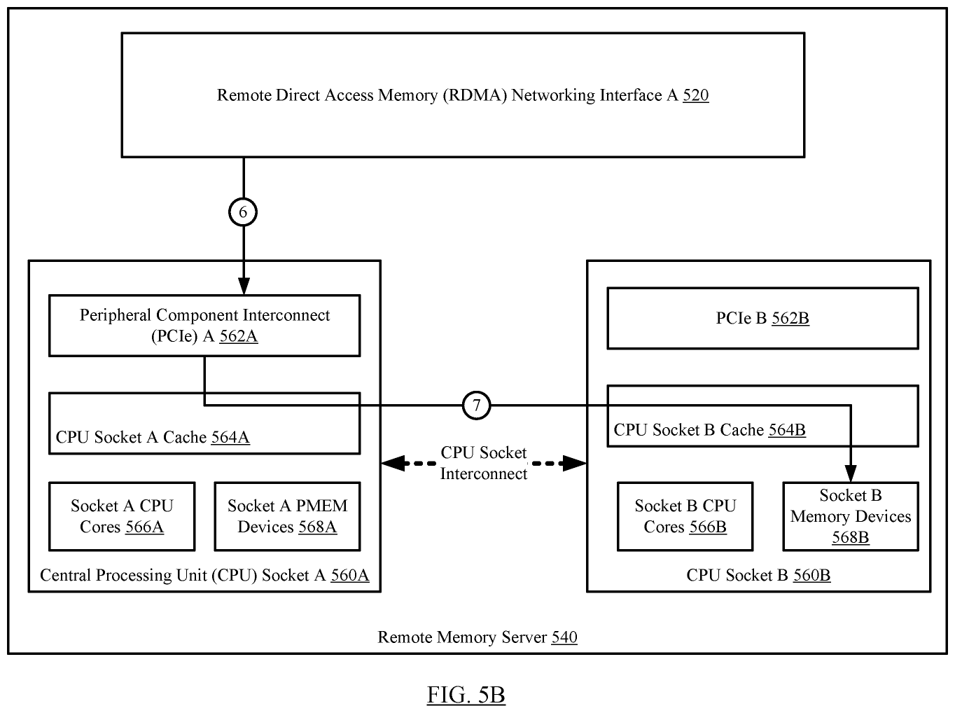

In one or more embodiments, the processor cores (156) may be operably connected to external resources (e.g., RDMA fabric devices) via the RDMA networking interface (166) and the RDMA-enabled network (120). Though the operable connection is provided, the processor cores (156) may not utilize the resources of the RDMA fabric network devices. For example, any RDMA requests (discussed in FIGS. 3A-3B and 4) serviced using the remote memory server (150) may not require the use of the processor cores (156). For additional details regarding the above example, see, e.g., FIGS. 5A-5B.

In one or more embodiments, the compute resource set (152) may be implemented using one or more sockets. In one or more embodiments, a socket is a device that provides direct connection between electrical components (e.g., microprocessors, motherboard, etc.) in a processor. The socket may be arranged, for example, in a pin grid array (PGA) architecture. Each socket may include a set of processor cores, a set of processor dedicated memory, and a connection to one of the compute resources interfaces (162). In such embodiments where the compute resource set (152) includes two or more sockets, the multiple sockets may provide a connection to the other sockets in the remote memory server (150) via, for example, a socket interconnect. The socket interconnects may be implemented as, for example, an ultra-path interconnect (UPI). Other socket interconnects may be used without departing from the invention.

Examples of compute resource sets include, but are not limited to, single-core CPUs, multi-core CPUs, graphics processing units (GPUs), and field programmable gate arrays (FPGAs).

In one or more embodiments of the invention, the RDMA networking interface (166) includes functionality for distributing the storage of data between the memory devices (170) and external components (e.g., RDMA fabric devices in the RDMA-enabled network (120)) The RDMA networking interface (166) may access the memory devices (170) via one or more compute resources interfaces (162).

The compute resources interface (162) may be implemented using any suitable interconnection technology including, for example, system buses such as compute express links or other interconnection protocols. For example, the compute resources interface (162) may be implemented as a peripheral component interconnect express (PCIe) device. The compute resources interface (162) may support any input/output (IO) protocol, any memory protocol, any coherence interface, etc. The compute resources interface (162) may support processor to device connections, processor to memory connections, and/or other types of connections. The compute resources interface (162) may be implemented using one or more hardware devices including circuitry adapted to provide the functionality of the compute resources interface (162).

The RDMA networking interface (166) may be implemented using any suitable interconnection technology including, for example, system buses such as compute express links or other interconnection protocols. The RDMA networking interface (166) may support any input/output (IO) protocol, any memory protocol, any coherence interface, etc. The RDMA networking interface (166) may support processor to device connections, processor to memory connections, and/or other types of connections. The RDMA networking interface (166) may be implemented using one or more hardware devices including circuitry adapted to provide the functionality of the RDMA networking interface (166) described herein.

In one or more embodiments, the memory devices (170) are devices that store memory. The memory devices (172, 174) may be implemented as, for example, solid-state memory devices, non-volatile dual in-line memory modules (NVDIMMs), or non-volatile random access memory (NVRAM). The memory devices (170) may be other types of memory devices without departing from the invention. The memory devices (170) may be connected to the remote memory server (150) via the compute resource interfaces (162).

To further clarify the relationship between the virtual memory address space and the memory regions of the remote memory server, FIG. 2 shows a diagram of the relationships between the virtual memory address space and the physical memory regions.

The diagram of FIG. 2 shows a client device (250), which may be an embodiment of the client device (140, FIG. 1A) described above, and a remote memory server (260), which may be an embodiment of a remote memory server (132, 134, FIG. 1A) discussed above. The client device (250) may include a page fault handler (252) that manages a virtual memory address space (202), which may be an embodiment of a virtual memory address space (144A, 144M, FIG. 1A) discussed above. The virtual memory address space (202), as discussed in FIG. 2, includes any number of virtual memory regions. Each virtual memory region maps to a virtual memory region hosted by the remote memory server (260), as illustrated by the solid arrows in FIG. 2. For example, virtual memory region 0 maps to virtual memory region 0 hosted by remote memory server (260), virtual memory region 1 of the virtual memory address space (202) maps to virtual memory region 1 hosted by remote memory server (260), and virtual memory region N of the virtual memory address space (202) maps to virtual memory region N hosted by remote memory server (260). In one or more embodiments, each virtual memory region may correspond to a memory page. The memory page may be of any fixed size without departing from the invention.

On the remote memory server (260), the remote virtual memory address (212) of the remote memory server (260) may map to physical memory of the remote memory server (260), as represented by the dashed arrows in FIG. 2. In one or more embodiments, the mapping of the remote virtual memory address (212) to the physical memory regions of the remote memory server (260) is not tracked by the client device.

In one or more embodiments, the page fault handler (252) manages the access of data in memory from obtained requests that invoke page faults. The page fault handler (252) may manage such access by converting the obtained requests to RDMA requests and issuing the RDMA requests across the RDMA network (120, FIG. 1A) to the remote server (260). Each RDMA request may correspond to a virtual memory region of the virtual memory address space (202). For example, for a first request that specifies data associated with virtual memory region 0, the page fault handler (252) may generate an RDMA request for accessing the data of the corresponding virtual memory region of the remote virtual memory address space (212). As discussed throughout, each virtual memory region may correspond to a memory page.

FIGS. 3A-3B show a flowchart for a method for managing remote shared memory in accordance with one or more embodiments of the invention. The method shown in FIGS. 3A-3B may be performed by, for example, a page fault handler (146A, 146M, FIG. 1A) of a client device. Other components of the system illustrated in FIGS. 1A-1B may perform the method of FIGS. 3A-3B without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

Turning to the method, in step 300 (FIG. 3A), an application request to access data is obtained. The application request may specify writing data to a virtual address in memory. The application request may be obtained from an application executing on the client device.

In step 302, the application requesting is decoded using the virtual memory address to identify a set of processor instructions in the application requests that each invoke a page fault. In one or more embodiments, the decoding is performed using a multi-level look-up-table (LUT) instruction decoding scheme. In one or more embodiments, the multi-level LUT instruction decoding scheme includes using LUTs to decode the address modes used for each processing instruction and to determine the source and destination registers to read data from or write data from. For example, consider a multi-level LUT instruction decoding scheme that includes a first LUT level that corresponds to the first byte of each of the processor instructions being decoded that would invoke a page fault (e.g., specify a virtual address of the unmapped virtual memory address space). In this example, a first LUT is populated with a first set of processor instructions that meet the criteria for the first LUT level. A second LUT level may be used to populate a second LUT with a subset of the first set of processor instructions. The multi-level LUT instructions scheme may utilize any number of LUT levels such that a predefined criteria properly narrows the processor instruction to identify the set of processor instructions that invoke the page faults

In one or more embodiments of the invention, the processor instructions are issued as single instruction, multiple data (SIMD) instructions. The SIMD instructions may be a type of processor instruction that corresponds to servicing multiple portions of data with one instruction. For example, consider a scenario in which each processor instruction processes eight bytes of data. A SIMD instruction may be issued to process eight of these processor instructions in parallel, thus specifying 64 bytes of data to be stored at a time.

In step 304, a determination is made about whether a selected processor instruction is a load operation or a store operation. If the processor instruction is a load operation, the method proceeds to step 306; otherwise, the method proceeds to step 308.

In step 306, a RDMA request is generated for reading data associated with the processor instruction from a remote virtual memory region associated with the virtual memory region of the virtual memory address space.

In step 308, a RDMA request is generated for writing data associated with the processor instruction to a remote virtual memory region associated with the virtual memory region of the virtual memory address space.

Turning to FIG. 3B, following the generation of the RDMA request of either steps 306 or 308, an instruction pointer of the application request may be adjusted to service the next processor in the application request.

In step 312, a determination is made about whether all processor instructions invoking a page faults are serviced. If all such processor instructions are serviced, the method ends following step 312; otherwise, the method returns to step 304 of FIG. 3A.

In one or more embodiments, the generated RDMA request is transmitted to a RDMA-enabled network to be serviced by a remote memory server. In one or more embodiments of the invention, the RMDA request may be serviced by mapping, by a RDMA networking interface of the remote memory server, the specified virtual memory address to a corresponding physical memory region and writing (if the RDMA request is a write request) the data to the physical memory region or copying (if the RDMA request is a read request) the data and providing the copy of the data to the client device. The RDMA request may be processed via any other method and by any other entity without departing from the invention.

FIG. 4 shows a flowchart for obtaining requests to access data at a remote direct memory access (RDMA) fabric device in accordance with one or more embodiments of the invention. The method shown in FIG. 3B may be performed by, for example, a RDMA networking interface (166, FIG. 1B) of a remote memory server (150). Other components of the system illustrated in FIGS. 1A-1C may perform the method of FIG. 4 without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 400, the RDMA request is obtained. In one or more embodiments of the invention, the RDMA request obtained by the RDMA fabric device is the RDMA request transmitted in FIGS. 3A-3B. The RDMA request may be obtained from a page fault handler of the client device. As discussed above, the RDMA request may specify a remote virtual memory region.

In step 402, the memory device associated with the remote virtual memory region specified in the RDMA request is identified. In one or more embodiments, the RDMA networking interface of the remote memory server includes a mapping that associates the remote virtual memory region a physical memory region of the memory device. The RDMA networking interface utilizes the mapping to identify the corresponding physical memory region.

In step 404, the identified memory device is accessed to service the RDMA request. In one or more embodiments, the memory device of the remote memory server is accessed without the use of the processor (e.g., the processor cores) of the remote memory server. In this manner, the remote memory server may continue operation on the compute processor set (e.g., executing other applications, performing other processes, etc.) without the servicing of the RDMA request significantly affecting the operation.

In one or more embodiments of the invention, the RDMA request is a read request. Servicing the read request may include obtaining a copy of the data and providing the copy of the data to the client device.

In one or more embodiments of the invention, the RDMA request is a write request. Servicing the write request may include writing specified data to the persistent memory address and providing an acknowledgement (e.g., an ACK) that the data was written as requested.

### Example

The following section describes an example. The example, illustrated in FIGS. 5A-5B, is not intended to limit the invention.

Turning to the example, consider a scenario in which a client device utilizes remote memory of a memory server in accordance with one or more embodiments of the invention. In the following example, a sequence of operations, illustrated in FIGS. 5A-5B as circled numbers, are described below using brackets (e.g., “[1]”).

FIG. 5A shows an example system. The example system includes a client device (530) and a remote memory server (540). The client device (530) includes an application (500) that uses a virtual memory address space (510) to store and access data stored in remote memory. The virtual memory address space (510) includes virtual memory regions A-D (510A, 510B, 510C, 510D). The virtual memory regions (510A, 510B, 510C, 510D) are unmapped to any physical memory. The access to the remote memory by the application (500) is managed by a page fault handler (502) of the client device (530). In this example, the client device (530) includes a central processing unit (CPU) (not show) that operates using a x86 instruction set architecture. Further, a single-instruction, multiple data (SIMD) computer architecture may be implemented in this example.

At a first point in time, the application (400) determines that it wants to write data to remote memory [1]. The data is a 4 kilobyte (KB) contiguous data block. The application (500) sends an application request that specifies storing the data in a virtual address in virtual memory region A (510A) [2]. The application request includes 512 processor instructions each specifying an eight-byte block of the 4 KB data. The 512 processor instructions may be issued as SIMD instructions, each specifying writing up to 64 bytes of data. Each of the 64 SIMD processor instructions is an instruction written as a x86 SIMD instruction that specifies writing 64 bytes of data from one or more registers in the CPU to a virtual address of a virtual memory address space. Given that every virtual address in virtual memory region A (510A) is unmapped, each of the 64 SIMD processor instructions will invoke eight page faults, each corresponding to an unmapped eight-byte page.

The page fault handler (502) performs the methods of FIGS. 3A-3B to manage the page faults [3]. Specifically, the page fault handler (502) identifies the 64 SIMD processor instructions in the application request that invoked the page faults, and, for each of the 64 processor instructions, determines page fault offsets corresponding to the 64-byte portion of data, and generates a remote direct memory access (RDMA) write request associated with each SIMD instruction using a RDMA networking interface controller (RNIC) (504) of the client device (530) [4]. This may result in 64 RDMA requests generated, each corresponding to one of the 64 SIMD instructions. Each of the 64 RDMA write requests specifies writing a corresponding 64-byte portion of the data to a specified memory region of the remote memory server (540) based on the determined page fault offsets. Each of the 64 RDMA write requests are transmitted to a RDMA networking interface (520) of the remote memory server (540) using the RNIC (504) [5].

Turning to FIG. 5B, the remote memory server (540) includes two CPU sockets: CPU socket A (560A) and CPU socket B (560B). Each CPU socket (560A, 560B) includes a peripheral connect interface express PCIe (562A, 562B), CPU socket cache (564A, 564B), a set of CPU cores (566A, 566B), and three of the memory devices (568A, 568B). In this example, each socket memory device of the socket memory devices (568A, 568B) is associated with a memory region that provides remote memory to the client device (530, FIG. 5A) and other client devices utilizing the shared memory system. The memory region specified in the 64 RDMA requests is hosted by the socket B memory devices (568B), connected to CPU socket B (560B). As illustrated in FIG. 5B, RDMA networking interface (520) connects to the remote memory server (540) via PCIe A (562A) of CPU socket A (560A) [6]. To access the remote memory region in CPU socket B (560B), RDMA networking interface (520) connects to PCIe A (462A), services the RDMA requests (e.g., the write requests to the memory address in the socket B memory devices (568B)) via the components within the illustrated path of [7].

In this example, the CPU cores (466A, 466B) execute processes that are not related to the RDMA request, nor do they utilize the persistent memory devices (468A, 468B). Further, the CPU cores (466A, 466B) do not utilize all of the respective cache (464A, 464B). As such, some of the cache (464A, 464B) is available for use for the servicing of the RDMA request and future RDMA requests. The RDMA networking interface (520) performs the method of FIG. 4 to identify the memory region associated with each memory address of each of the 512 RDMA requests. The RDMA networking interface (520) determines that the memory addresses are associated with a memory region of socket B memory device (568B).

### End of Example

As discussed above, embodiments of the invention may be implemented using computing devices. FIG. 6 shows a diagram of a computing device in accordance with one or more embodiments of the invention. The computing device (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), input devices (610), output devices (608), and numerous other elements (not shown) and functionalities. Each of these components is described below.

In one embodiment of the invention, the computer processor(s) (602) may be an integrated circuit for processing instructions. For example, the computer processor(s) may be one or more cores or micro-cores of a processor. The computing device (600) may also include one or more input devices (610), such as a touchscreen, keyboard, mouse, microphone, touchpad, electronic pen, or any other type of input device. Further, the communication interface (612) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment of the invention, the computing device (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention improve the availability of the storage of data in memory. By storing data in remote memory, embodiments provide the availability of memory by external devices while maintaining low latency. By virtualizing processor instructions to RDMA requests, the low latency is maintained while also maintaining coherency of memory between the client device accessing the remote server and the remote server accessing its own memory. The coherency is maintained without the required use of application programming interfaces (APIs) to managing the coherency of multiple entities accessing the same physical memory region. Embodiments disclosed herein provide methods for directly accessing the remote memory, which reduces the requirement to manage the coherency of memory storage by two or more entities.

Thus, embodiments of the invention may address the problem of inefficient use of computing resources. This problem arises due to the technological nature of the environment in which resource devices are utilized.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A system for managing remote memory, comprising:
a client device comprising a page fault handler and a virtual memory address space;
a remote direct memory access (RDMA) network; and
a remote memory server comprising a RDMA networking interface,
wherein the page fault handler is programmed to:
obtain an application request associated with a virtual memory address of the virtual memory address space;
decode the application request to using the virtual memory address to identify a set of processor instructions in the application request, wherein each of the set of processor instructions invokes a page fault;
for a processor instruction of the set of processor instructions:
generate a RDMA request for accessing a virtual memory region of the remote memory server;
issue the RDMA request to the RDMA networking interface via the RDMA network; and
adjust an instruction pointer of the processor instruction to service a second instruction pointer of the set of processor instructions.

2. The system of claim 1, further comprising:
an application,
wherein the application request is obtained from the application, and
wherein the application utilizes the virtual memory address space for memory storage.

3. The system of claim 1, wherein each of the set of processor instructions specifies a virtual memory page.

4. The system of claim 1, wherein the virtual memory address space is not mapped to any physical memory of the client device.

5. The system of claim 1, wherein the page fault handler does not map the virtual memory address to physical memory prior to adjusting the instruction pointer.

6. The system of claim 1, wherein the remote memory server further comprises a virtual remote memory address space and physical memory.

7. The system of claim 6,
wherein the processor instruction is a store operation for data,
wherein the RDMA request is a write request specifying data in the virtual remote memory address space, and
wherein the RDMA networking interface is programmed to service the RDMA request by writing the data to a physical memory region of the physical memory.

8. The system of claim 6,
wherein the processor instruction is a load operation for data,
wherein the RDMA request is a read request specifying data in the virtual remote memory address space, and
wherein the RDMA networking interface is programmed to service the RDMA request by copying the data from a physical memory region of the physical memory and providing the data to the client device.

9. The system of claim 1, wherein the RDMA networking interface is a RDMA network interface controller (RNIC).

10. A method for managing remote memory, comprising:
obtaining, by a page fault handler of a client device, an application request associated with a virtual memory address of a virtual memory address space;
decoding the application request using the virtual memory address to identify a set of processor instructions in the application request, wherein each of the set of processor instructions invokes a page fault;
for a processor instruction of the set of processor instructions:
generating a remote direct memory access (RDMA) request for accessing a virtual memory region of a remote memory server;
issuing the RDMA request to a RDMA networking interface via an RDMA network; and
adjusting an instruction pointer of the processor instruction to service a next instruction pointer of the set of processor instructions.

11. The method of claim 10, wherein the application request is obtained from an application, and wherein the application utilizes the virtual memory address space for memory storage.

12. The method of claim 10, wherein each of the set of processor instructions specifies a virtual memory page.

13. The method of claim 10, wherein the virtual memory address space is not mapped to any physical memory of the client device.

14. The method of claim 10, wherein the page fault handler does not map the virtual memory address to physical memory prior to adjusting the instruction pointer.

15. The method of claim 10, wherein the remote memory server comprises a virtual remote memory address space and physical memory.

16. The method of claim 15,
wherein the processor instruction is a store operation for data,
wherein the RDMA request is a write request specifying data in the virtual remote memory address space, and
wherein the RDMA networking interface is programmed to service the RDMA request by writing the data to a physical memory region of the physical memory.

17. The method of claim 15,
wherein the processor instruction is a load operation for data,
wherein the RDMA request is a read request specifying data in the virtual remote memory address space, and
wherein the RDMA networking interface is programmed to service the RDMA request by copying the data from a physical memory region of the physical memory and providing the data to the client device.

18. A non-transitory computer readable medium comprising computer readable program code, which when executed by a computer processor enables the computer processor to perform a method for managing remote memory, the method comprising:
obtaining, by a page fault handler of a client device, an application request associated with a virtual memory address of a virtual memory address space;
decoding the application request to using the virtual memory address to identify a set of processor instructions in the application request, wherein each of the set of processor instructions invokes a page fault;
for a processor instruction of the set of processor instructions:
generating a remote direct memory access (RDMA) request for accessing a virtual memory region of a remote memory server;
issuing the RDMA request to a RDMA networking interface via an RDMA network; and
adjusting an instruction pointer of the processor instruction to service a next instruction pointer of the set of processor instructions.

19. The non-transitory computer readable medium of claim 18, wherein the virtual memory address space is not mapped to any physical memory of the client device.

20. The non-transitory computer readable medium of claim 18, wherein the page fault handler does not map the virtual memory address to physical memory prior to adjusting the instruction pointer.
